(19) United States
(12) Patent Application Publication
(10) Pub. No.: US 2021/0345138 A1
(43) Pub. Date: Nov. 4, 2021

(54) Enabling Prediction of Future Operational Condition for Sites

(71) Applicant: Telefonaktiebolaget LM Ericsson (publ), Stockholm (SE)

(72) Inventors: Konstantinos Vandikas, Solna (SE); Athanasios Karapantelakis, Solna (SE); David Lindero, Luleå (SE); Bin Sun, Luleå (SE)

(21) Appl. No.: 17/283,453

(22) PCT Filed: Oct. 11, 2018
(86) PCT No.: PCT/EP2018/077710

§ 371 Date: Apr. 7, 2021

(51) Int. Cl. H04W 24/04; H04W 24/08; G06K 9/62; H04W 84/04; G06N 20/00; G06N 5/04

(52) U.S. Cl. CPC H04W 24/04; H04W 24/08; G06N 5/045; H04W 84/04; G06N 20/00; G06K 9/6227

(57) ABSTRACT

It is provided a method for enabling prediction of a future operational condition for at least one site, each site comprising at least one radio network node of a radio access technology, RAT, of a cellular network. The method comprises the steps of: obtaining input properties of the at least one site; selecting a plurality of machine learning models based on the input properties; and activating the selected plurality of machine learning models in an inference engine, such that all of the selected plurality of machine learning models are collectively applicable to enable prediction of a future operational condition of the at least one site.

### TECHNICAL FIELD

The invention relates to a method, an operational condition predictors, a computer program and a computer program product for enabling prediction of future operational condition for sites, each site comprising at least one radio network node.

### BACKGROUND

In cellular networks, an operator controls a number of sites, where each site is provided with one or more network nodes for providing connectivity to instances of user equipment, UEs. A single site can have several radio network nodes supporting different radio access technologies (RATs), i.e. different types of cellular networks.

A Network Operations Centre (NOC) is used to monitor and control the cellular networks of the operator. When an alarm is raised in a NOC, it is typically associated with a certain site and this is vital to the process of troubleshooting.

A number of different operating conditions can happen to sites. For instance, grid power may fail and secondary power, such as batteries or generators, may eventually run out. Another operating condition is a sleeping cell, where the radio network node broadcasts its presence to UEs, but the radio network node is unable to set up any traffic channels.

### SUMMARY

It would be of great benefit if operating conditions of sites of radio network nodes could be predicted better.

According to a first aspect, it is provided a method for enabling prediction of a future operational condition for at least one site, each site comprising at least one radio network node of a radio access technology, RAT, of a cellular network. The method comprises the steps of: obtaining input properties of the at least one site; selecting a plurality of machine learning models based on the input properties; and activating the selected plurality of machine learning models in an inference engine, such that all of the selected plurality of machine learning models are collectively applicable to enable prediction of a future operational condition of the at least one site.

The method may further comprise the step of: obtaining a specific future operational condition to be predicted. In such a case, the step of selecting a plurality of machine learning models is also based on the specific future operational condition; and the step of activating the selected plurality of machine learning models enables prediction of the specific future operational condition.

In the step of selecting a plurality of machine learning models, at least one machine learning model may have been filtered to omit data according to a configuration by the source entity of each of the at least one machine learning model.

The method may further comprise the step of: determining weights of each one of the selected plurality of machine learning models. In such a case, in the step of activating the selected plurality of machine learning models, the weights are provided for the collective application of the selected plurality of machine learning models.

The method may further comprise the steps of: receiving feedback from at least one user equipment device, UE, relating to accuracy of the collectively applied machine learning models; and adjusting the weights based on the feedback.

The input properties may comprise keywords and/or key-value pairs.

The input properties may relate to at least one of: supported RATs, power source(s), geographical region, latitude and longitude, antenna height, tower height, battery installation date, number of diesel generators, fuel tank size, on-air-date, number of cells and spectrum coverage, location, battery capacity, sector azimuth(s), sector spectrum, area type, radio access channel success rate over time, throughput over time, and latency over time.

The future operational condition may be any one of: power outage, sleeping cell, degradation of latency, and degradation of throughput.

According to a second aspect, it is provided an operational condition predictor for enabling prediction of a future operational condition for at least one site, each site comprising at least one radio network node of a radio access technology, RAT, of a cellular network. The operational condition predictor comprises: a processor; and a memory storing instructions that, when executed by the processor, cause the operational condition predictor to: obtain input properties of the at least one site; select a plurality of machine learning models based on the input properties; and activate the selected plurality of machine learning models in an inference engine, such that all of the selected plurality of machine learning models are collectively applicable to enable prediction of a future operational condition of the at least one site.

The operational condition predictor may further comprise instructions that, when executed by the processor, cause the operational condition predictor to: obtain a specific future operational condition to be predicted. In such a case, the instructions to select a plurality of machine learning models is also based on the specific future operational condition; and the instructions to activate the selected plurality of machine learning models enable prediction of the specific future operational condition.

In the instructions to select a plurality of machine learning models, at least one machine learning model may have been filtered to omit data according to a configuration by the source entity of each of the at least one machine learning model.

The operational condition predictor may further comprise instructions that, when executed by the processor, cause the operational condition predictor to: determine weights of each one of the selected plurality of machine learning 3o models. In such a case, the instructions to activate the selected plurality of machine learning models comprise instructions that, when executed by the processor, cause the operational condition predictor to provide the weights for the collective application of the selected plurality of machine learning models.

The operational condition predictor may further comprise instructions that, when executed by the processor, cause the operational condition predictor to: receive feedback from at least one user equipment device, UE, relating to accuracy of the collectively applied machine learning models; and adjust the weights based on the feedback.

The input properties may comprise keywords and/or key-value pairs.

The input properties may relate to at least one of: supported RATs, power source(s), geographical region, latitude and longitude, antenna height, tower height, battery installation date, number of diesel generators, fuel tank size, on-air-date, number of cells and spectrum coverage, location, battery capacity, electric power source, sector azimuth(s), sector spectrum, area type, radio access channel success rate over time, throughput over time, and latency over time.

The future operational condition may be any one of: power outage, sleeping cell, degradation of latency, and degradation of throughput.

According to a third aspect, it is provided an operational condition predictor comprising: means for obtaining input properties of at least one site, each site comprising at least one radio network node of a radio access technology, RAT, of a cellular network; means for selecting a plurality of machine learning models based on the input properties; and means for activating the selected plurality of machine learning models in an inference engine, such that all of the selected plurality of machine learning models are collectively applicable to enable prediction of a future operational condition of the at least one site.

According to a fourth aspect, it is provided a computer program for enabling prediction of a future operational condition for at least one site, each site comprising at least one radio network node of a radio access technology, RAT, of a cellular network. The computer program comprises computer program code which, when run on an operational condition predictor causes the operational condition predictor to: obtain input properties of the at least one site; select a plurality of machine learning models based on the input properties; and activate the selected plurality of machine learning models in an inference engine, such that all of the selected plurality of machine learning models are collectively applicable to enable prediction of a future operational condition of the at least one site.

According to a fifth aspect, it is provided a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment in which embodiments presented herein can be applied;

FIGS. 2A-C are schematic diagrams illustrating embodiments of where an operational condition predictor can be implemented;

FIGS. 3A-B are flow charts illustrating embodiments of methods for enabling prediction of a future operational condition one or more sites;

FIG. 4 is a schematic diagram illustrating components of the operational condition predictor of FIGS. 2A-C according to one embodiment;

FIG. 5 is a schematic diagram showing functional modules of the operational condition predictor of FIGS. 2A-C according to one embodiment; and

FIG. 6 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Embodiments presented herein enable the cross-use of machine learning models, even between different operators. The selection of what machine learning models to employ is based on the input properties of at least one site. The selected machine learning models are then collectively used to predict a future operational condition of the at least one site.

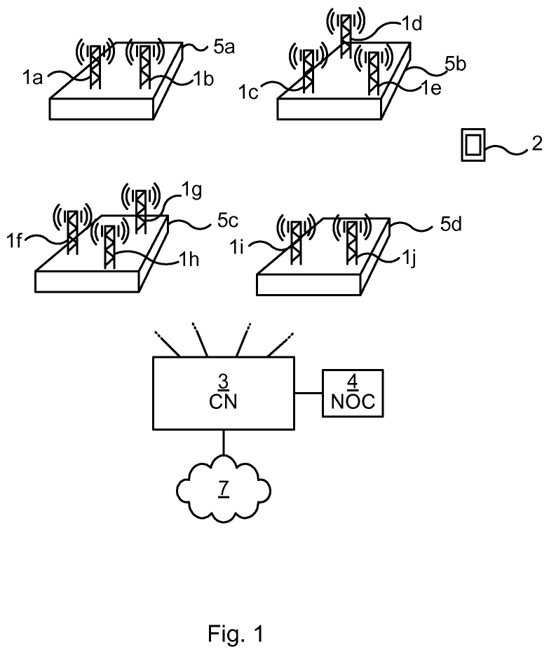

FIG. 1 is a schematic diagram illustrating an environment where embodiments presented herein may be applied. A cellular network operator, hereinafter simply referred to as ‘operator’, has a number of sites 5a-d, in this example four sites 5a-d. In reality there are typically many more sites under control of the operator, but four sites are shown here for clarity of explanation. Hereinafter, the reference numeral 5 refers to any suitable site, e.g. one of the sites 5a-d of FIG. 1. A site 5 is a location hosting equipment, in this case one or more radio network nodes. Each site 5 has a number of properties, e.g. based on location and technical properties of the site 5 and network nodes, as described in more detail below.

Each site 5a-d is used to provide cellular network coverage using one or more radio access technologies (RAT). The operator can support one or more different types of cellular networks. Each type of cellular network utilises a RAT. For instance, one or more RATs can be selected from the list of 5G NR (New Radio), LTE (Long Term Evolution), LTE-Advanced, W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), GSM, or any other current or future wireless network, as long as the principles described hereinafter are applicable. The site 5 is responsible for providing a suitable environment, e.g. in the form of a building, for the radio network nodes to be able to provide coverage. For power, each site 5a-d is usually connected to an electric grid as a primary power source. Additionally, the site 5 can also provide one or more secondary power sources, such as solar power, wind generator, batteries, and diesel generator.

Since many operators provide coverage using several RATs, each site 5a-d can host several radio network nodes, where each radio network node can support a different RAT. In the example of FIG. 1, a first site 5a hosts a first radio network node 1a and a second radio network node ib. A second site 5b hosts a third radio network node 1c, a fourth radio network node id and a fifth radio network node 1e. A third site 5c hosts a sixth radio network node if, a seventh radio network node 1g and an eighth radio network node 1g. A fourth site 5d hosts a ninth radio network node ii and a tenth radio network node 1j.

The radio network nodes 1a-j are in the form of radio base stations being any one of evolved Node Bs, also known as eNode Bs or eNBs, g Node Bs, Node Bs, BTSs (Base Transceiver Stations) and/or BSSs (Base Station Subsystems), etc.

The radio network nodes 1a-j provide radio connectivity over a wireless interface to a plurality of instances of user equipment (UE) 2. The term UE is also known as mobile communication terminal, mobile terminal, user terminal, user agent, subscriber terminal, subscriber device, wireless device, wireless terminal, machine-to-machine device etc., and can e.g. be in the form of what today are commonly known as a mobile phone, smart phone or a tablet/laptop with wireless connectivity.

Over the wireless interface, downlink (DL) communication occurs from the radio network nodes 1a-j to the UE 2 and uplink (UL) communication occurs from the UE 2 to the radio network nodes 1a-j. The quality of the wireless radio interface to each UE 2 can vary over time and depending on the position of the UE 2, due to effects such as fading, multipath propagation, interference, etc.

For each RAT, a number of network nodes are connected to a core network (CN) 3 for connectivity to central functions and a wide area network 7, such as the Internet. A Network Operations Centre (NOC) 4 is connected to the core network 3 to monitor and control the cellular networks of the operator. A single NOC 4 can be employed for several different cellular networks of the operator or different NOCs can be used for different cellular networks.

According to embodiments presented herein, it is provided an operational condition predictor to predict when problems in sites 5 of the cellular network are likely to occur.

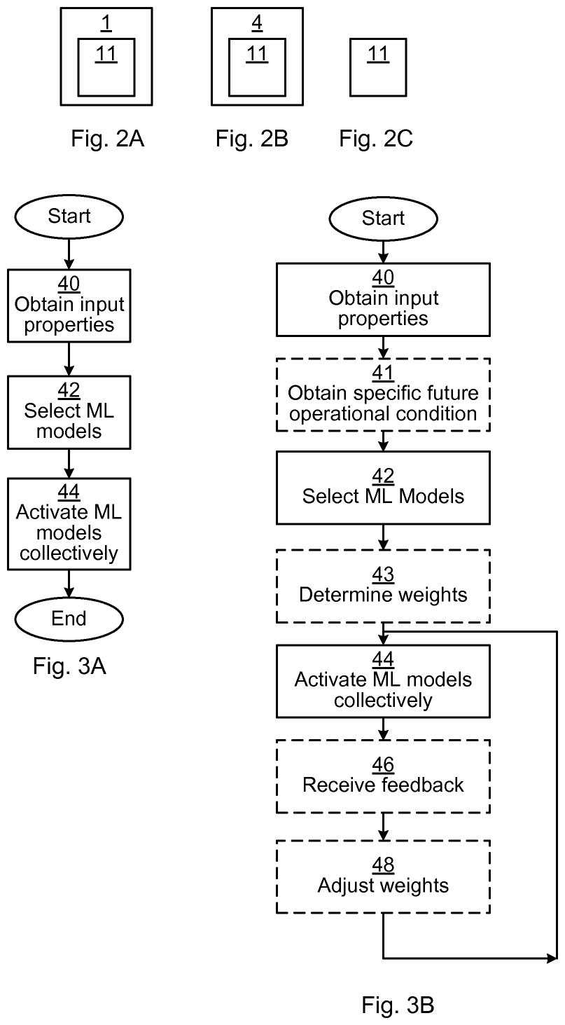

FIGS. 2A-C are schematic diagrams illustrating embodiments of where the operational condition predictor 11 can be implemented.

In FIG. 2A, the operational condition predictor 11 is shown implemented in a radio network node 1, which e.g. can be any one of the radio network nodes of FIG. 1. The radio network node 1 is thus the host device for the operational condition predictor 11 in this implementation. This embodiment corresponds to an edge network implementation.

In FIG. 2B, the operational condition predictor 11 is shown implemented in the NOC 4. The NOC 4 is thus the host device for the operational condition predictor 11 in this implementation.

In FIG. 2C, the operational condition predictor 11 is shown implemented as a stand-alone device. The operational condition predictor 11 thus does not have a host device in this implementation. The operational condition predictor 11 can thus be implemented anywhere suitable, e.g. in the cloud.

FIGS. 3A-B are flow charts illustrating embodiments of methods for enabling prediction of a future operational condition one or more sites 5. The method is performed for a set of the one or more sites 5, which can be all, or a subset of all, sites 5 of the operator. The future operational condition can e.g. be any one (or a combination) of: power outage, or sleeping cell, degradation of latency, and degradation of throughput. As described above, each site 5 comprises at least one radio network node 1 of an RAT of a cellular network. The methods are performed in the operational condition predictor.

In an obtain input properties step 40, the operational condition predictor obtains input properties of the at least one site 5. The input can be received from an operator terminal (e.g. of the NOC 4) or from a server instructing the operational condition predictor to perform this method, e.g. on a scheduled basis or based on a certain condition. The input properties can comprise keywords. Each keywords is a property which either exists or not for the site 5. Alternatively or additionally, the input properties comprise key-value pairs. Each key-value pair is made up of a key and a value, where the key is a label indicating the use of the key-value pair and the value is a measurement for that particular key. The input properties relate to at least one of:

supported RATs, power source(s), geographical region, latitude and longitude, antenna height, tower height, battery installation date, number of diesel generators, fuel tank size (for the generator(s)), on-air-date, number of cells and spectrum coverage, location, battery capacity, sector azimuth(s), sector spectrum, area type (e.g. urban, rural, suburban), radio access channel success rate over time, throughput over time, and latency over time.

The input properties can contain static or configurable information obtained from a database. Alternatively or additionally, the input properties can contain dynamic information, e.g. obtained by querying the site 5 and/or radio network nodes 1 of the site 5.

In a select ML models step 42, the operational condition predictor selects a plurality of machine learning (ML) models based on the input properties. The ML models can be ML models from different operators. The different ML models can be stored centrally or in different locations, e.g. at each respective operator being a source for the ML model. This allows each operator to not only use its own ML models, but also to use the ML models of other operators to improve the prediction of operating conditions of sites 5. Since the selection of ML models is performed based on the input properties, ML models matching the one or more sites 5 are preferred. For instance, if the one or more sites 5 are in a rural location with a single diesel generator as backup power at a latitude of 35 degrees, ML models with similar characteristics are preferred.

For instance, a look up function can be used to compare the input parameters of the ML models available. Using a similarity technique, the top-k models are selected that match the one or more sites 5 depending on the future operational condition to be predicted.

In one embodiment, at least one ML model has been filtered to omit data according to a configuration by the source entity of each of the at least one ML model. In other words, each operator can then configure what data should form part of the ML model to be shared. This configuration can be based on business decisions and/or on regulations on what data that can be shared. The sharing of data across operators can be sensitive, which is mitigated in this way.

The ML models are already in a state to be used, i.e. have been appropriately set up and trained in any suitable way. For instance, the models might have been trained using counters such as RachSuccRate, UlSchedulerActivityRate_EWMALastiweek. RachSuccRate denotes a percentage of successful radio access establishments using random access. UlSchedulerActivityRate_EWMALastiweek denotes an aggregate counter measuring the Uplink Scheduler Activity Rate for the past week. A time window is used which aggregates data over a period. This counter measures how many times different uplink tasks have been scheduled. The counter used to train the ML model can be one of the input parameters of step 40 above.

Examples of potentially sensitive data include mobile subscriber location, type of traffic generated by subscribes, call data records, etc. It is to be noted that the filtering of data can imply removing data, or anonymising data (e.g. by means of k-anonymization such as suppression and generalization).

In an activate ML models collectively step 44, the operational condition predictor activates the selected plurality of ML models in an inference engine, such that all of the selected plurality of ML models are collectively applicable to enable prediction of a future operational condition of the at least one site 5. The combining of the ML models can e.g. be performed using boosting or bagging, as known in the art per se.

In boosting some points from a dataset are selected at random, resulting in learning and building a model, and then testing the model against the selected points. For any incorrect predictions, the boosting procedure will pay more attention. The process is repeated until all predictions are correct, or the rate of correct predictions is greater than a threshold. Subsequently, a consensus model is built. In case of classification problems (e.g. trying to identify root cause of an issue), a voting process can be used, wherein each individual model identifies the root cause and the root cause with the most votes wins. In case of regression problems (e.g. estimating churn propensity scores for mobile subscribers) a consensus model can be built either by simple averaging (e.g. mean computation) or weighed averaging of the produced models. The consensus model is more accurate than the individual models, as it eliminates bias of individual models, thus improving predictions at-large.

The inference engine is the entity which performs the actual prediction based on the ML models. The inference engine can form part of the NOC 4 or can be implemented in a separate device located elsewhere. Optionally, the inference engine can be implemented in the same physical device as the operational conditional predictor.

Given the predictive nature of ML models, these can be triggered ahead of time based on the validity of the prediction. For instance, if a prediction is meant to be valid (to a certain degree of certainty) for X hours, inference can be triggered X hours ahead of time minus the time it takes for the actual computation for the prediction to be generated. Aside from the temporal dimension, additional criteria can be considered for triggering this process. In one embodiment, specific alarms popping up on a NOC 4 are considered. In one embodiment, specific sites 5 that have been addressed as a consequence of an ML prediction are considered. This can be used to verify the quality of the prediction as well as the resolution that has been applied.

Looking now to FIG. 3B, only new or modified steps compared to the steps of FIG. 3A will be described.

In an optional obtain specific future operational condition step 41, the operational condition predictor obtains a specific future operational condition to be predicted. In such a case, the select ML models step 42 is also based on the specific future operational condition. Furthermore, the activate ML models collectively step 44, enables prediction of the specific future operational condition.

In an optional determine weights step 43, the operational condition predictor determines weights of each one of the selected plurality of ML models. When weights are determined, the activate ML models collectively step 44 comprises providing the weights for the collective application of the selected 3o plurality of ML models. For instance, an ML model which best matches the one or more sites 5 can be weighted higher than an ML model which does not match as well.

In an optional receive feedback step 46, the operational condition predictor receives feedback from at least one UE 2. The feedback relates to accuracy of the collectively applied ML models. For instance, information relating to the predicted operational condition (e.g. sleeping cell, reduced throughput, etc.) can form part of the feedback, to allow evaluation of the ML models.

In an optional adjust weights step 48, the operational condition predictor adjusts the weights based on the feedback. In this way, the ML models are to rewarded or penalised according to its accuracy (which is checked with the feedback). After the weights are adjusted, the method returns to the activate ML models collectively step 44, to thereby apply the adjusted weights.

By using the feedback to adjust the weights, the operator can get feedback as to how robust a particular ML model is. This may be particularly useful when the model is deployed in a new setting, even with data that is has never seen. A general risk of ML models is that they can be over fitted or develop biases to the input training dataset, which is mitigated using this feedback loop. Using the weight adjustment, the performance of a combination of ML models 2 is improved, compensating for any inefficacies identified in step 46.

According to embodiments presented herein, it is made possible to re-use ML models developed to predict problems for different operators. Moreover, this enables further improvement on these models by combining them and by evaluating their efficiency. The embodiments thus enable the transfer of learning between operators and/or for different deployments within the domain of an operator. In other words, models are used to solve a different problem without exposing the data used for the initial training of the ML model. Optionally, an ML model can be further trained after deployment. Consequently, the embodiments presented herein are beneficial both for new operators deploying a network and for existing operators expanding their networks or for continuous performance improvements.

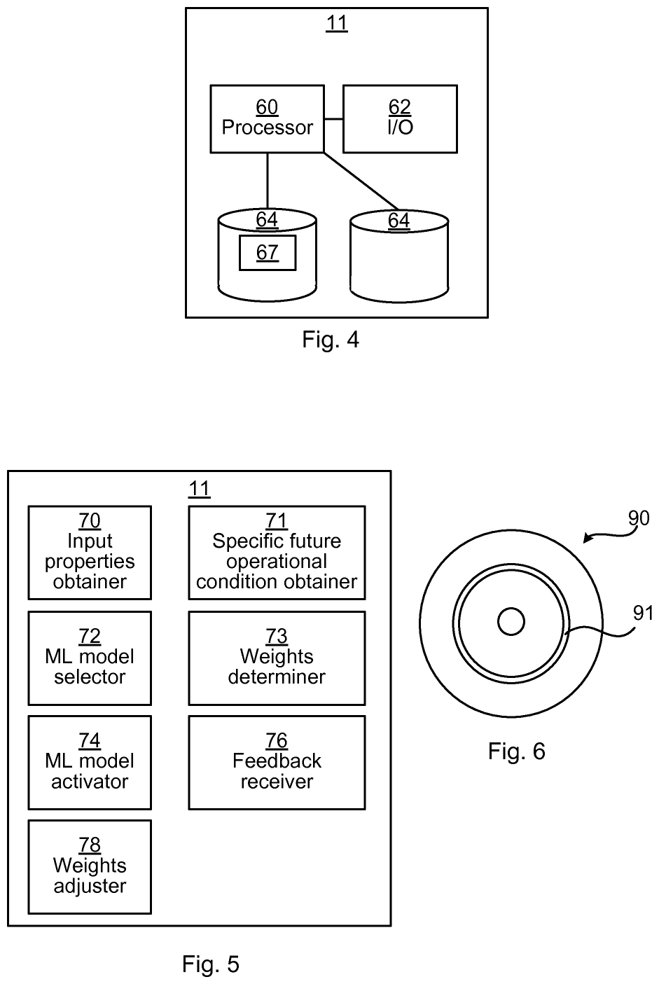

FIG. 4 is a schematic diagram illustrating components of the operational condition predictor of FIGS. 2A-C according to one embodiment. It is to be noted that one or more of the mentioned components can be shared with the host device, such as for the embodiments illustrated in FIGS. 2A-B and described above. A processor 60 is provided using any combination of one or more of a suitable central processing unit (CPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-B above.

The memory 64 can be any combination of random access memory (RAM) and/or read only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The operational condition predictor 11 further comprises an I/O interface 62 for communicating with external and/or internal entities. Optionally, the I/O interface 62 also includes a user interface.

Other components of the operational condition predictor 11 are omitted in order not to obscure the concepts presented herein.

FIG. 5 is a schematic diagram showing functional modules of the operational condition predictor of FIGS. 2A-C according to one embodiment. The modules are implemented using software instructions such as a computer program executing in the operational condition predictor 11. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

An input properties obtainer 70 corresponds to step 40. A specific future operational condition obtainer 71 corresponds to step 41. An ML model selector 72 corresponds to step 42. A weights determiner 73 corresponds to step 43. An ML model activator 74 corresponds to step 44. A feedback receiver 76 corresponds to step 46. A weights adjuster 78 corresponds to step 48.

FIG. 6 shows one example of a computer program product comprising computer readable means. On this computer readable means, a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product ### of Fig ###. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1-21. (canceled)

22. A method for enabling prediction of a future operational condition for at least one site, each site comprising at least one radio network node of a radio access technology (RAT) of a cellular network, the method comprising:
obtaining input properties of the at least one site;
selecting a plurality of machine learning models based on the input properties; and
activating the selected plurality of machine learning models in an inference engine, such that all of the selected plurality of machine learning models are collectively applicable to enable prediction of a future operational condition of the at least one site.

23. The method of claim 22, further comprising:
obtaining a specific future operational condition to be predicted;
and wherein selecting the plurality of machine learning models is also based on the specific future operational condition; and
wherein activating the selected plurality of machine learning models enables prediction of the specific future operational condition.

24. The method of claim 22, wherein in selecting a plurality of machine learning models, at least one machine learning model is filtered to omit data according to a configuration by the source entity of each of the at least one machine learning model.

25. The method of claim 22, further comprising:
determining weights of each one of the selected plurality of machine learning models;
and wherein in activating the selected plurality of machine learning models, the weights are provided for the collective application of the selected plurality of machine learning models.

26. The method of claim 25, further comprising:
receiving feedback from at least one user equipment device (UE) relating to accuracy of the collectively applied machine learning models; and
adjusting the weights based on the feedback.

27. The method of claim 22, wherein the input properties comprise keywords.

28. The method of claim 22, wherein the input properties comprise key-value pairs.

29. The method of claim 22, wherein the input properties relate to at least one of: supported RATs, power source(s), geographical region, latitude and longitude, antenna height, tower height, battery installation date, number of diesel generators, fuel tank size, on-air-date, number of cells and spectrum coverage, location, battery capacity, sector azimuth(s), sector spectrum, area type, radio access channel success rate over time, throughput over time, and latency over time.

30. The method of claim 22, wherein the future operational condition is any one of: power outage, sleeping cell, degradation of latency, and degradation of throughput.

31. A operational condition predictor for enabling prediction of a future operational condition for at least one site, each site comprising at least one radio network node of a radio access technology (RAT) of a cellular network, the operational condition predictor comprising:
a processor; and
a memory storing instructions that, when executed by the processor, cause the operational condition predictor to:
obtain input properties of the at least one site;
select a plurality of machine learning models based on the input properties; and
activate the selected plurality of machine learning models in an inference engine, such that all of the selected plurality of machine learning models are collectively applicable to enable prediction of a future operational condition of the at least one site.

32. The operational condition predictor of claim 31, further comprising instructions that, when executed by the processor, cause the operational condition predictor to:
obtain a specific future operational condition to be predicted;
and wherein the instructions are configured to select the plurality of machine learning models based also on the specific future operational condition.

33. The operational condition predictor of claim 31, wherein in the instructions to select a plurality of machine learning models, at least one machine learning model is filtered to omit data according to a configuration by the source entity of each of the at least one machine learning model.

34. The operational condition predictor of claim 31, further comprising instructions that, when executed by the processor, cause the operational condition predictor to:
determine weights of each one of the selected plurality of machine learning models;
and wherein the instructions to activate the selected plurality of machine learning models comprise instructions that, when executed by the processor, cause the operational condition predictor to provide the weights for the collective application of the selected plurality of machine learning models.

35. The operational condition predictor of claim 34, further comprising instructions that, when executed by the processor, cause the operational condition predictor to:
receive feedback from at least one user equipment device (UE) relating to accuracy of the collectively applied machine learning models; and
adjust the weights based on the feedback.

36. The operational condition predictor of claim 31, wherein the input properties comprise keywords.

37. The operational condition predictor of claim 31, wherein the input properties comprise key-value pairs.

38. The operational condition predictor of claim 31, wherein the input properties relate to at least one of: supported RATs, power source(s), geographical region, latitude and longitude, antenna height, tower height, battery installation date, number of diesel generators, fuel tank size, on-air-date, number of cells and spectrum coverage, location, battery capacity, electric power source, sector azimuth(s), sector spectrum, area type, radio access channel success rate over time, throughput over time, and latency over time.

39. The operational condition predictor of claim 31, wherein the future operational condition is any one of: power outage, sleeping cell, degradation of latency, and degradation of throughput.

40. A operational condition predictor comprising:
means for obtaining input properties of at least one site, each site comprising at least one radio network node of a radio access technology (RAT) of a cellular network;
means for selecting a plurality of machine learning models based on the input properties; and
means for activating the selected plurality of machine learning models in an inference engine, such that all of the selected plurality of machine learning models are collectively applicable to enable prediction of a future operational condition of the at least one site.
